(19) United States
(12) Patent Application Publication
(10) Pub. No.: US 2005/0050466 A1
(43) Pub. Date: Mar. 3, 2005

(54) Distributed automated workflow assignment for print fulfillment of print jobs

(76) Inventors: James M. Sangroniz, Boise, ID (US); Jody L. Terrill, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/652,408

(22) Filed: Aug. 29, 2003

(51) Int. Cl. G06F 17/00

(52) U.S. Cl. 715/526

(57) ABSTRACT

Various systems, methods, and computer programs embodied in a computer-readable medium for print fulfillment in a print facility having a central print orchestrator and a plurality of print sub-processes, where each print sub-process implements a partial print fulfillment of a print job. In this respect, a job ticket that describes the characteristics of a finished document is modified to include a print process workflow and print sub-process workflows. The print processor workflow directs the routing of the job ticket to print sub-processes and the print sub-process workflows direct a partial print fulfillment of the finished document in a print sub-process.

### CROSS REFERENCE TO RELATED APPLICATIONS

This application is related to co-pending U.S. patent application entitled “AUTOMATED WORKFLOW ASSIGNMENT TO PRINT JOBS,” filed on Mar. 24, 2003, and assigned Ser. No. 10/395,795.

### BACKGROUND

The Internet and other networks have made it possible for individuals to submit print jobs to print shops for printing. It is now possible to transmit print jobs directly to print shops that can then print the documents and supply them to the sender for a fee. Such print jobs may include a job ticket that specifies particular characteristics about the document to be printed. Job tickets may be expressed, for example, using a Job Definition Format (JDF) that provides a standard for the expression of job tickets. Unfortunately, the print workflow is not typically included in such job tickets as every print shop may have unique print production facilities.

### BRIEF DESCRIPTION OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a print facility according to an embodiment of the present invention;

FIG. 2 is a second block diagram of the print facility of FIG. 1 that further illustrates a central print orchestrator and print sub-processes of FIG. 1 according to an embodiment of the present invention;

FIG. 3 is a block diagram of a chained arrangement of subordinate workflow assignment engines that perform the tasks associated with a single workflow assignment engine of FIG. 2; and

FIG. 4 is a schematic diagram of one example of the print facility of FIG. 2 according to an embodiment of the present invention.

### DETAILED DESCRIPTION

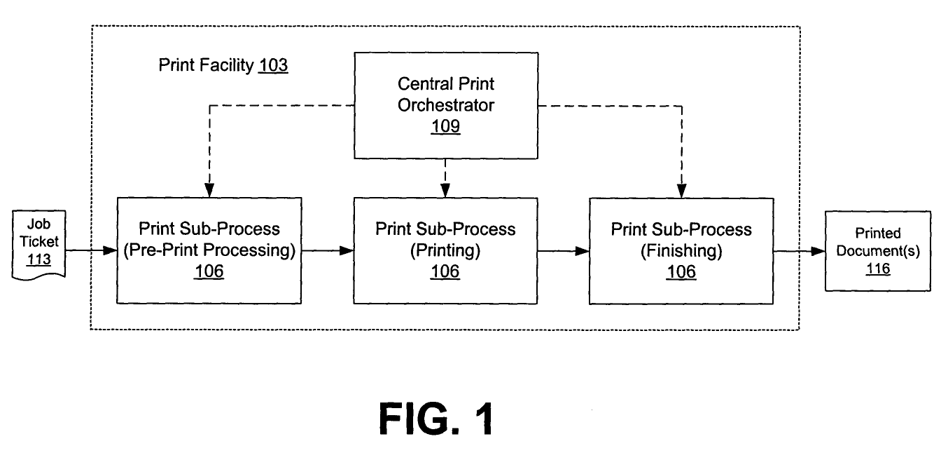

With reference to FIG. 1, shown is a block diagram of a print facility 103 according to an embodiment of the present invention. The print facility 103 may be, for example, a facility such as print shop that is localized in one location or a distributed facility that is embodied in a number of locations or buildings scattered across a large geographical area. The print facility 103 includes a number of print sub-processes 106 such as, for example, pre-print processing, printing, finishing, and other processes performed in printing or otherwise producing documents in a print facility 103. Examples of pre-print processing can include color correction to achieve a desired visual result, imposition involving laying out pages and/or adding marks to pages, and/or format conversion to convert a document from one format to another (i.e. PDF to PostScript). Other examples may include proofing of documents by creation of a physical or electronic proof to verify intended results, screening such as a process of half-tone screening, trapping involving modifying files to compensate for offset issues on certain printing presses, or Raster Image Processing (RIPping) which involves interpreting and rendering documents to create graphical output. Examples of printing processes may include conventional printing such as printing from a physical master like traditional offset printing, digital printing which involves printing directly from digital information and eliminates extra mediums such as a printing plate, or integrated digital printing that may combine traditional pre-press and post-press processes into the printing process. Also, post press or finishing processes or operations in a print facility 103 can include binding pages together in various formats such as coil, binder, stitched, or tape binding, cutting printing sheets such as cutting press sheets to finished product dimensions, folding finished sheets into an appropriate product type (e.g. a brochure), inserting additional material into the print product such as page separators, and/or laminating such as bonding a plastic film to one or both sides of printed pages. In addition, other print sub-processes 106 may include approval of documents (either interim or final approvals), delivery (of proof and final), and/or packing such as delivery to a next process or final delivery. In addition, it is possible that various print sub-processes 106 described above may fall into more than one of the categories described above (i.e. pre-printing, printing, and post-printing/finishing). Thus, a print sub-process 106 is defined here as print functions or operations that are grouped according to their relative stage or position in a complete print process.

The print facility 103 also includes one or more central print orchestrators 109 that control a flow of a print job through the print sub-processes 106. In this respect, a job ticket 113 is received in the print facility 103 from a client (not shown). The job ticket 113 describes a number of characteristics of a finished document that is associated with the print job. In this respect, the job ticket 113 may be expressed in an appropriate language such as, for example, extensible markup language (XML) or other language. In this respect, the job tickets 153 may conform to the JDF Specification, Release 1.1, Revision A, copyright 2000-2002, as published by the CIP4 (International Cooperation for Integration of Processes in Prepress, Press, and Postpress). The central print orchestrator 109 examines the job ticket 113 and determines which one or more of the print sub-processes 106 are necessary to accomplish the complete print fulfillment of the print job, thereby creating the printed documents 116. Thereafter, the central print orchestrator 109 automatically routes the job ticket to the one or more print sub-processes 106 to accomplish the complete print fulfillment of the print job as will be discussed in greater detail below. In this respect, the complete print fulfillment of the print job involves the completion of all print tasks necessary to produce the final product including all print sub-processes as described above. Thus, the central print orchestrator 109 and the print sub-processes 106 make up an automated print fulfillment system operating within a particular print facility 103.

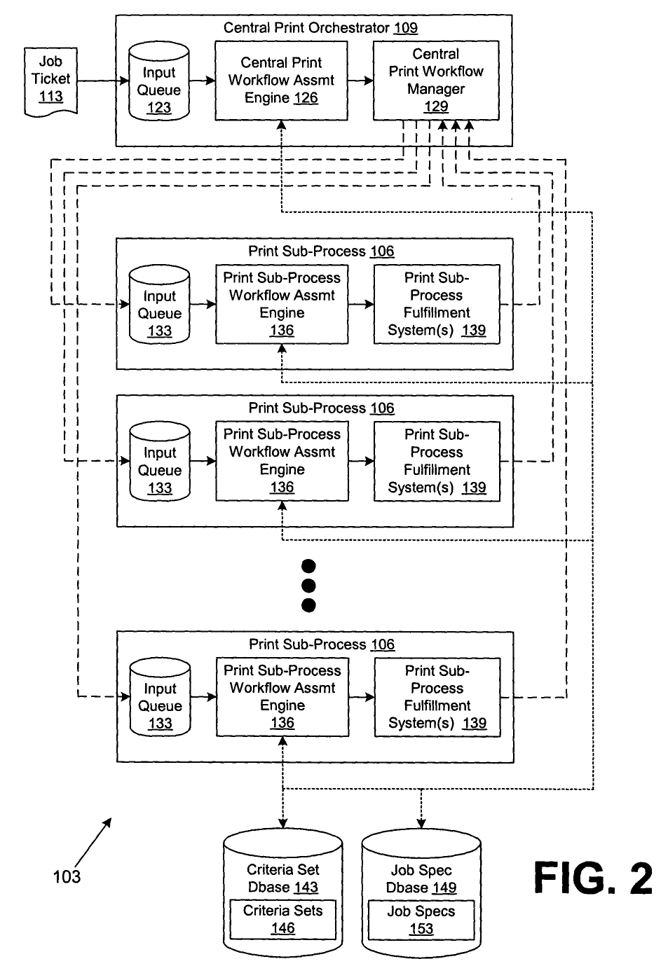

With reference to FIG. 2, shown is a block diagram of the print facility 103 according to an embodiment of the present invention. In this respect, the print facility 103 includes the central print orchestrator 109 and a number of print sub-processes 106. The central print orchestrator 109 includes an input queue 123, a central print workflow assignment engine 126, and a central print workflow manager 129. Similarly, each of the print sub-processes 106 includes an input queue 133, a print sub-process workflow assignment engine 136, and one or more print sub-process fulfillment systems 139. The print facility 103 also includes a criteria set database 143 within which is stored a number of criteria sets 146. The criteria sets 146 are employed to determine how the job ticket 113 is to be modified to include print process workflows and sub-print process workflows as will be discussed. Also, the print facility 103 includes a job specification database 149 within which are stored a number of job specifications 153. Each of the job specifications 153 include information that describes a particular print process workflow or print sub-process workflow that is included or merged with the job ticket 113 when the job ticket 113 is modified as will be described in greater detail below. As an alternative, the print facility 103 may include a number of criteria set databases 143 and a number of job specification databases 149 such that the central print orchestrator 109 and each print sub-process 106 includes their own criteria set and job specification databases 143 and 149.

Next the operation of the print facility 103 is described in detail. To begin, a job ticket 113 is received from a client, for example, through a network or from a computer-readable medium such as a portable data storage device, etc. The job ticket 113 is associated with a print job and describes a number of characteristics of a finished document that is to be printed. The actual document that is to be printed may accompany the job ticket 113 in digital form or a reference to the actual document stored in an appropriate server or computer system on a network may be included in the job ticket 113. Alternatively, the actual document may be associated with the job ticket 113 in some other manner.

When the job ticket 113 is first received, it is stored in the input queue 123 to wait for further processing along with other job tickets 113 previously received. The central print workflow assignment engine 126 then obtains the job ticket 113 from the input queue 123. The central print workflow assignment engine 126 performs the task of automatically modifying the job ticket 113 in the central print orchestrator 109 to include a print process workflow. The print process workflow routes the job ticket 113 to one or more print sub-processes 106. The combination of the operations performed in each of the print sub-processes 106 as outlined in the print process workflow results in the complete print fulfillment of the print job in that the print documents 116 are completely produced as specified by the job ticket 113.

In order to modify the job ticket 113, the central print workflow assignment engine 126 compares predefined ones of the criteria sets 146 in the criteria set database 143 with the content of the job ticket 113. In this respect, predefined ones of the criteria sets 146 are associated with the central print workflow assignment engine 126. Likewise, a number of criteria sets 146 are also uniquely associated with each of the print sub-process workflow assignment engine 136. Thus, each of the criteria sets 146 include, for example, an assignment engine identifier that uniquely associates each criteria set 146 with one of the workflow assignment engines 126 or 136.

Associated with each criteria set 146 is a corresponding job specification 153. In this respect, each job specification 153 may include a criteria set identifier that associates the job specification 153 with a corresponding criteria set 146. The central print workflow assignment engine 126 compares each of its associated criteria sets 146 with various content items in the job ticket 113. The criteria sets 146 may be compared with the job ticket 113 in a predefined order. When the content of the job ticket 113 matches the criteria expressed in a particular criteria set 146, then the central print workflow assignment engine 126 obtains the job specification 153 that is associated with the criteria set 146 from the job specification database 149. In addition, various ones of the criteria sets 146 may include criteria directed to a current state or environment of the print facility 103. For example, criteria may examine various factors such as whether various print queues are too full, whether workflow congestion exists in various ones of the print sub-processes 106, or other such factors. As such, the corresponding job specifications 153 may express a print process workflow or print sub-process workflow that is related to the state of the print facility 103 as well as the content of the job ticket 113.

Once the associated job specification 153 is identified, the central print workflow assignment engine 126 merges or otherwise includes the print process workflow from the job specification 153 into the job ticket 113. For a more detailed discussion of the operations involved in merging or otherwise including the print process workflow from a respective job specification 153 into the job ticket 113, reference is made to co-pending U.S. patent application entitled “Automated Workflow Assignment to Print Jobs” filed on Mar. 24, 2003 and assigned Ser. No. 10/395,795 which is incorporated herein by reference in its entirety.

Once the job ticket 113 has been modified to include the appropriate print process workflow as described above, the central print workflow assignment engine 126 relays the job ticket 113 to the central print workflow manager 129. The central print workflow manager 129 then interfaces with each of the print sub-processes 106 to automatically route the job ticket 113 to one or more print sub-processes as directed by to the print process workflow. The central print workflow manager 129 routes the job ticket 113 to each print sub-process 106 consecutively according to an order indicated in the print process workflow. When routing the job ticket 113 to a respective one of the print sub-processes 106, the central print workflow manager 129 places the job ticket 113 into the input queue 133 associated with the respective one of the print sub-processes 106. When placed into one of the input queues 133, the job ticket 113 does not include the print sub-process workflow necessary to accomplish the partial print fulfillment within the respective print sub-process 106. When the various operations necessary to perform the partial print fulfillment have taken place in the respective one of the print sub-processes 106, the job ticket 113 is returned to the central print workflow manager 129 that further routes the job ticket 113 to other print sub-processes 106 to accomplish the complete print fulfillment of the print job in a like manner. Thus, the print process workflow directs the routing of the job ticket 113 to one or more of the print sub-processes 106 to effect the complete print fulfillment of the print job. In this respect, each of the print sub-processes performs or accomplishes a partial print fulfillment of the print job.

After a job ticket 113 is placed in an input queue 133 of a respective one of the print sub-processes 106, it waits to be processed by the corresponding print sub-process workflow assignment engine 136. When appropriate, the print sub-process workflow assignment engine 136 obtains the job ticket 113 from the input queue 133 and proceeds to automatically modify the job ticket to include a print-sub process that directs the implementation of a partial print fulfillment of the print job in the corresponding print sub-process 106. In this respect, the print sub-process workflow assignment engine 136 compares a number of criteria sets 146 that are uniquely associated with the print sub-process workflow assignment engine 136 to the job ticket 113 in a manner similar to that described above with reference to the central print workflow assignment engine 126. In this respect, once one of the criteria sets 146 that includes criteria that matches the content of the job ticket 113 is identified, then the job specification 153 that corresponds to the matching criteria set 146 is obtained from the job specification database 149.

Thereafter, the print sub-process workflow expressed in the job specification 153 is merged into or otherwise included in the job ticket 113. In this respect, the operation of each of the print sub-process workflow assignment engines 136 is similar or identical to the operation of the central print workflow assignment engine 126. In this manner, a more detailed discussion of the operations involved in merging or otherwise including a print sub-process workflow from a respective job specification 153 into the job ticket 113, reference is made once again to co-pending U.S. patent application entitled “Automated Workflow Assignment to Print Jobs” filed on Mar. 24, 2003 and assigned Ser. No. 10/395,795 which is incorporated herein by reference in its entirety.

In a typical situation, the merging or inclusion of the print sub-process workflow into the job ticket 113 generally involves modifying a specific portion of the job ticket 113. This is because in the typical situation, only a portion of the content of the job ticket 113 is relevant to the operations and/or tasks undertaken in a respective one of the print sub-processes 106. As stated above, the print sub-process workflow directs the implementation of the partial print fulfillment within the respective print sub-process 106. In particular, the print sub-process workflow is interpreted by one or more print sub-process fulfillment systems 139 associated with the respective print sub-process 106 that proceed to automatically perform the various operations and tasks necessary to achieve the partial print fulfillment within the respective print sub-process 106.

Once the print sub-process workflow is merged into or otherwise included in the job ticket 113, then the respective print sub-process workflow assignment engine 136 hands the job ticket 113 off to the respective print sub-process fulfillment systems 139 to effect the implementation of the partial print fulfillment in the print sub-process as directed by the print sub-process workflow. In this respect, the print sub-process fulfillment systems 139 may access an actual document(s) associated with the job ticket 113 expressed in digital form in order to perform various printing operations. Alternatively, the various operations or tasks associated with a respective print sub-process may involve further processing of printed documents such as would be the case with finishing operations, etc.

The central print workflow manager 129 of the central print orchestrator 109 is configured for easy addition of print sub-processes 106. Specifically, to add a print sub-process 106 to a print facility 103, the central print workflow manager 129 need only be modified to include an interface with the additional print sub-process 106. Specifically, the interface may include a network location of the appropriate input queue 133 associated with the new print sub-process 106. Also, one or more criteria sets 146 and their corresponding job specifications 153 need to be created and added to the criteria set database 143 and the job specification database 149. According to one aspect of the present invention, the logical operation of the print sub-process workflow assignment engines 136 and the central print workflow assignment engine 126 are identical or are substantially identical. Consequently, there is no need to generate new ones of the print sub-process workflow assignment engines 136 to add a new print sub-process 106 to a print facility. However, the print sub-process fulfillment systems 139 are generally unique to the respective print sub-process 106 and reflect the printing capabilities of a particular print facility 103.

Also, it may be possible that a print sub-process workflow assignment engine 136 modify the job ticket 113 in a manner similar to the central print workflow assignment engine 126 where the print sub-process workflow included in the job ticket 113 directs a sub-process print workflow manager 129 to route the job ticket 113 to further sub-processes 106. In this manner, the print process fulfillment systems 139 may be organized according to a hierarchy of print functions. Thus, the printing capabilities and other operational aspects of a particular print facility may be distributed among many more print sub-processes 106.

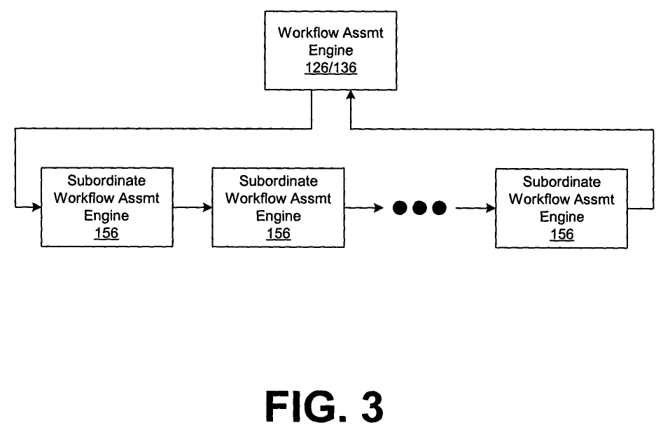

With reference to FIG. 3, shown is a block diagram that illustrates a distributed nature of either the central print workflow assignment engine 126 or the print sub-process workflow assignment engine 136 according to an embodiment of the present invention. In this respect, either the operation of either the central print workflow assignment engine 126 or any one of the print sub-process workflow assignment engines 136 may be implemented by chaining a number of subordinate workflow assignment engines 156 together in succession, where each subordinate workflow assignment engine 156 performs the task of altering the job ticket 113 to merge or otherwise include a portion of the print process workflow or the print sub-process workflow into the job ticket 113. In this respect, each of the subordinate workflow assignment engines 156 may be identical to the workflow assignment engines 126/136, but may employ different ones of the criteria sets 146 and their associated job specification 153. In this respect, the tasks performed by each of the subordinate workflow assignment engines 156 in including workflow information into the job ticket 113 is localized in such a manner that the corresponding criteria sets 146 and job specifications 153 are much more simple to create.

The distributed manner of the printing capabilities and other operational aspects of a particular print facility as discussed above with reference to FIGS. 2 and 3 provides a significant advantage in that the criteria sets 146 and the job specifications 153 are smaller and more simple to create, thereby providing an automated print fulfillment system that can be easily customized for any print facility 103. This is because the central print orchestrator 109 and the various print sub-processes 106 are independent from each other and, thus, the need only be as complex as is necessary to accomplish the specific tasks and/or operations with which they are presented. Also, the automated print fulfillment system can be easily modified or expanded to accommodate future growth, etc.

In addition, the central print workflow assignment engine 126 is configurable to specify the input queue 123 from which the job tickets 113 are to be obtained from and to specify that the central print workflow manager 129 is where job tickets 113 altered by the central print workflow assignment engine 126 are to be transferred. Similarly, each of the print sub-process workflow assignment engines 136 are configurable to specify the respective input queue 133 from which the job tickets 113 are to be obtained from and to specify the respective print sub-process fulfillment systems 139 to which job tickets 113 altered by the print sub-process workflow assignment engines 136 are to be transferred. In this respect, the central print workflow assignment engine 126 and each of the print sub-process workflow assignment engines 136 are replaceable by alternate or updated workflow assignment engines.

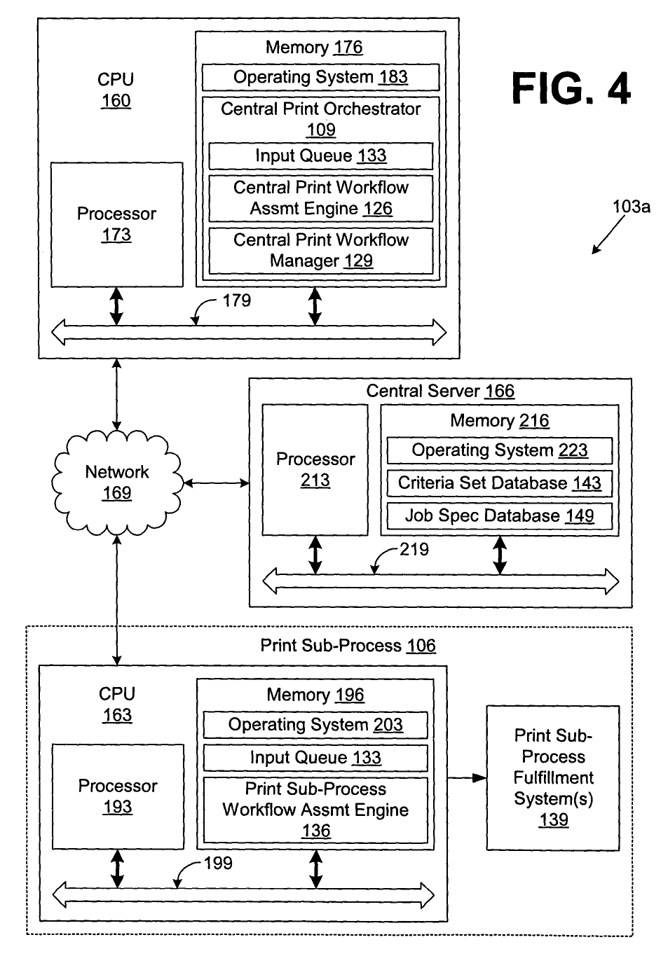

Referring next to FIG. 4, shown is a block diagram that illustrates one example of a print facility 103a according to an embodiment of the present invention. Specifically, the print facility 103a includes central processing units (CPUS) 160 and 163 as well as a central server 166. Each of the CPUs 160, 163 and the central server 166 are coupled to a network 169. In this respect, the network 169 may be, for example, The network 169 may comprise, for example, the Internet, intranets, wide area networks (WANs), local area networks, wireless networks, or other suitable networks, etc., or any combination of two or more such networks. The network 169 facilitates data communication between any two components on any one of the CPUs 160, 163 and the central server 166 as can be appreciated by those with ordinary skill in the art. The CPU 163 is a portion of the print sub-process 106 in that it is employed to execute various components stored therein as will be discussed.

The CPU 160 includes a processor circuit having a processor 173 and a memory 176, both of which are coupled to a local interface 179. In this respect, the local interface 179 may be, for example, a data bus with an accompanying control/address bus as can be appreciated by those with ordinary skill in the art. In this respect, the CPU 160 may be contained, for example, in a computer system or other system with like capability.

Stored in the memory 176 and executable by the processor 173 is an operating system 183 and the central print orchestrator 109. In this respect, the central print orchestrator 109 includes the input queue 133, the central print workflow assignment engine 126, and the central print workflow manager 129. In addition, other components may be stored in the memory 176 and executable by the processor 173 beyond those described herein.

The CPU 163 includes a processor circuit having a processor 193 and a memory 196, both of which are coupled to a local interface 199. In this respect, the local interface 199 may be, for example, a data bus with an accompanying control/address bus as can be appreciated by those with ordinary skill in the art. In this respect, the CPU 163 may be contained, for example, in a computer system or other system with like capability.

Stored in the memory 196 and executable by the processor 193 is an operating system 203, an input queue 133, and a print sub-process workflow assignment engine 136. In addition, other components may be stored in the memory 196 and executable by the processor 193 beyond those described herein. The print sub-process workflow assignment engine 136 communicates with the print sub-process fulfillment system(s) 139 as is needed to implement the partial print fulfillment of the printed documents 116.

The central server 166 includes a processor circuit having a processor 213 and a memory 216, both of which are coupled to a local interface 219. In this respect, the local interface 219 may be, for example, a data bus with an accompanying control/address bus as can be appreciated by those with ordinary skill in the art. In this respect, the CPU 166 may be contained, for example, in a computer system or other system with like capability.

Stored in the memory 216 and executable by the processor 213 is an operating system 223, the criteria set database 143, and the job specification database 149. In addition, other components may be stored in the memory 216 and executable by the processor 213 beyond those described herein. In addition, other components may be stored in the memory 216 that are executed by the processor 213 that facilitate the transfer of criteria sets 146 and job specifications 153 from the criteria set database 143 and the job specification database 149 to the central print workflow assignment engine 126 and/or the print sub-process workflow assignment engine 136 as requested.

In addition, the various components described with reference to FIGS. 2 and 3 may be implemented in a configuration that differs from that described with reference to FIG. 4. For example, components that are executed in the CPU 163 may be executed on the CPU 160 in addition to those shown in the memory 176. Also, the criteria set database 143 and the job specification database 149 may be distributed among the central print orchestrator 109 and the print sub-processes 106, etc.

A number of software components are stored in the memories 176, 196, 216 and are executable by the respective processors 173, 193, 213. In this respect, the term “executable” means a program file that is in a form that can ultimately be run by a respective processor 173, 193, 213. Examples of executable programs may be, for example, a compiled program that can be translated into machine code in a format that can be loaded into a random access portion of the memories 176, 196, 216 and run by the respective processors 173, 193, 213, or source code that may be expressed in proper format such as object code that is capable of being loaded into a random access portion of the respective memory 176, 196, 216 and executed by the respective processor 173, 193, 213, etc. An executable program may be stored in any portion or component of a respective memory 176, 196, 216 including, for example, random access memory, read-only memory, a hard drive, compact disk (CD), floppy disk, or other memory components.

Each of the memories 176, 196, 216 are defined herein as both volatile and nonvolatile memory and data storage components. Volatile components are those that do not retain data values upon loss of power. Nonvolatile components are those that retain data upon a loss of power. Thus, each of the memories 176, 196, 216 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, each of the processors 173, 193, 213 may represent multiple processors and each of the memories 176, 196, 216 may represent multiple memories that operate in parallel processing circuits, respectively. In such a case, each of the local interfaces 179, 199, 219 may be an appropriate network that facilitates communication between any two of the multiple processors, between any processor and any of the memories, or between any two of the memories, etc. The processors 173, 193, 213 may be of electrical or optical construction, or of some other construction as can be appreciated by those with ordinary skill in the art.

The operating systems 183, 203, 223 are executed to control the allocation and usage of hardware resources such as the memory, processing time and peripheral devices in the CPUs 160, 163, and the central server 166. In this manner, the operating systems 183, 203, 223 serve as the foundation on which applications depend as is generally known by those with ordinary skill in the art.

Although the central print workflow assignment engine 126, the central print workflow manager 129, the print sub-process workflow assignment engine 136, and other components are described as being embodied in software or code executed by general purpose hardware as discussed above, as an alternative each such component may also be embodied in dedicated hardware or a combination of software/general purpose hardware and dedicated hardware. If embodied in dedicated hardware, each component can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The block diagrams of FIGS. 2-4 show the architecture, functionality, and operation of an implementation of the various components such as the central print workflow assignment engine 126, the central print workflow manager 129, the print sub-process workflow assignment engine 136, and other components. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Also, where the central print workflow assignment engine 126, the central print workflow manager 129, the print sub-process workflow assignment engine 136, and other components comprise software or code, each can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the central print workflow assignment engine 126, the central print workflow manager 129, the print sub-process workflow assignment engine 136, and other components for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

1. A method for print fulfillment in a print facility having a central print orchestrator and a plurality of print sub-processes, each print sub-process implementing a partial print fulfillment of a print job, comprising the steps of:
receiving a job ticket from a client in a central print orchestrator, the job ticket describing a number of characteristics of a finished document associated with the print job;
automatically modifying the job ticket in the central print orchestrator to include a print process workflow that routes the job ticket to at least one of the print sub-processes for a complete print fulfillment of the print job;
automatically routing the job ticket to the at least one of the print sub-processes according to the print process workflow;
automatically modifying the job ticket within the at least one of the print sub-processes to include a print sub-process workflow that directs the implementation of the partial print fulfillment in the at least one of the print sub-processes; and
implementing the partial print fulfillment in the at least one of the print sub-processes as directed by the print sub-process workflow.

2. The method of claim 1, wherein the step of automatically modifying the job ticket in the central print orchestrator to include the print process workflow that routes the job ticket to the at least one of the print sub-processes for the complete print fulfillment of the print job further comprises the step of comparing a content of the job ticket to at least one criteria set, the at least one criteria set including a set of criteria for determining whether a predefined print process workflow is to be included in the job ticket, wherein at least a portion of the criteria is directed to the content of the job ticket.

3. The method of claim 1, wherein the step of automatically modifying the job ticket in the central print orchestrator to include the print process workflow that routes the job ticket to the at least one of the print sub-processes for the complete print fulfillment of the print job further comprises the step of comparing a content of the job ticket to at least one criteria set, the at least one criteria set including a set of criteria for determining whether a predefined print process workflow is to be included in the job ticket, wherein at least a portion of the criteria is directed to a state of at least a portion of the printing facility.

4. The method of claim 1, wherein the step of automatically modifying the job ticket within the at least one of the print sub-processes to include the print sub-process workflow that directs the implementation of the partial print fulfillment in the at least one of the print sub-processes further comprises modifying a unique portion of the job ticket within each of the at least one of the print sub-processes.

5. The method of claim 1, wherein the step of automatically modifying the job ticket within the at least one of the print sub-processes to include the print sub-process workflow that directs the implementation of the partial print fulfillment in the at least one of the print sub-processes further comprises the step of merging the print sub-process workflow with a portion of the job ticket.

6. The method of claim 1, further comprising the step of adding an additional print sub-process to the printing facility.

7. A system for print fulfillment of a print job in a print facility, comprising:
a central print orchestrator and a plurality of print sub-processes, wherein the central print orchestrator is configured to receive a job ticket from a client, the job ticket describing a number of characteristics of a finished document associated with the print job;
a central print workflow assignment engine associated with the central print orchestrator, the central print orchestrator workflow assignment engine being configured to modify the job ticket to include a print process workflow that routes the job ticket to at least one of the print sub-processes for a complete print fulfillment of the print job; and
a print sub-process workflow assignment engine associated with each of the print sub-processes, each print sub-process workflow assignment engine being configured to modify the job ticket to include a print sub-process workflow that directs the implementation of a partial print fulfillment of the print job.

8. The system of claim 7, wherein the central print workflow assignment engine and the print sub-process workflow assignment engine are replaceable.

9. The system of claim 7, wherein the central print workflow assignment engine is configured to compare a content of the job ticket to at least one criteria set, the at least one criteria set including a set of criteria for determining whether a predefined print process workflow is to be included in the job ticket, wherein at least a portion of the criteria is directed to the content of the job ticket.

10. The system of claim 7, wherein the central print workflow assignment engine is configured to compare a content of the job ticket to at least one criteria set, the at least one criteria set including a set of criteria for determining whether a predefined print process workflow is to be included in the job ticket, wherein at least a portion of the criteria is directed to a state of at least a portion of the printing facility.

11. The system of claim 7, further comprising a central print workflow manager associated with the central print orchestrator, the central print workflow manager routing the job ticket to the at least one of the print sub-processes for a complete print fulfillment of the print job as directed by the central print workflow.

12. The system of claim 7, further comprising a print sub-process fulfillment system associated with each of the print sub-processes, wherein each print sub-process fulfillment system implements the partial print fulfillment within each respective one of the print sub-processes as directed by a corresponding print sub-process workflow.

13. The system of claim 7, wherein each of the print sub-process workflow assignment engines is configured to modify a unique portion of the job ticket.

14. The system of claim 7, wherein a logical operation of the central print workflow assignment engine is substantially similar to a logical operation of each of the print sub-process workflow assignment engines.

15. The system of claim 7, wherein the central print workflow assignment engine further comprises a number of subordinate workflow assignment engines chained in succession, wherein each of the subordinate workflow assignment engines is configured to modify the job ticket to include a portion of the print process workflow.

16. The system of claim 7, wherein the print sub-process workflow assignment engine further comprises a number of subordinate workflow assignment engines chained in succession, wherein each of the subordinate workflow assignment engines is configured to modify the job ticket to include a portion of the print sub-process workflow.

17. A program embodied in a computer readable medium for print fulfillment of a print job in a print facility having a central print orchestrator and a plurality of print sub-processes, each print sub-process implementing a partial print fulfillment of a print job, comprising:
an input queue configured to store a job ticket received from a client, the job ticket describing a number of characteristics of a finished document associated with the print job;
a central print workflow assignment engine associated with the central print orchestrator, the central print workflow assignment engine being configured to modify the job ticket to include a print process workflow that routes the job ticket to at least one of the print sub-processes for a complete print fulfillment of the print job; and
a print sub-process workflow assignment engine associated with each of the print sub-processes, each print sub-process workflow assignment engine being configured to modify the job ticket to include a print sub-process workflow that directs the implementation of a partial print fulfillment of the print job.

18. The program embodied in the computer readable medium of claim 17, wherein the central print workflow assignment engine and the print sub-process workflow assignment engine are replaceable.

19. The program embodied in the computer readable medium of claim 17, further comprising a central print workflow manager associated with the central print orchestrator, the central print workflow manager routing the job ticket to the at least one of the print sub-processes for a complete print fulfillment of the print job as directed by the central print workflow.

20. The program embodied in the computer readable medium of claim 17, wherein a logical operation of the central print workflow assignment engine is substantially similar to a logical operation of each of the print sub-process workflow assignment engines.

21. The program embodied in the computer readable medium of claim 17, wherein the central print workflow assignment engine further comprises a number of subordinate workflow assignment engines chained in succession, wherein each of the subordinate workflow assignment engines is configured to modify the job ticket to include a portion of the print process workflow.

22. The program embodied in the computer readable medium of claim 17, wherein the print sub-process workflow assignment engine further comprises a number of subordinate workflow assignment engines chained in succession, wherein each of the subordinate workflow assignment engines is configured to modify the job ticket to include a portion of the print sub-process workflow.

23. A system for print fulfillment of a print job in a print facility, comprising:
a central print orchestrator and a plurality of print sub-processes, wherein the central print orchestrator is configured to receive a job ticket from a client, the job ticket describing a number of characteristics of a finished document associated with the print job;
first means for modifying the job ticket to include a print process workflow that routes the job ticket to at least one of the print sub-processes for a complete print fulfillment of the print job, the first means being associated with the central print orchestrator; and
second means within each of the print sub-processes for modifying the job ticket to include a print sub-process workflow that directs the implementation of a partial print fulfillment of the print job within each of the print sub-processes, respectively.
